(19) United States
(12) Patent Application Publication
(10) Pub. No.: US 2010/0070502 A1
(43) Pub. Date: Mar. 18, 2010

(54) Collision Free Hash Table for Classifying Data

(75) Inventor: Robert J. Zigon, Carmel, IN (US)

Correspondence Address: STERNE KESSLER GOLDSTEIN & FOX, P.L.L.C., 1100 NEW YORK AVENUE, N.W., WASHINGTON, DC, 20005, US

(73) Assignee: Beckman Coulter, Inc., Fullerton, CA (US)

(21) Appl. No.: 12/211,794

(22) Filed: Sep. 16, 2008

(51) Int. Cl. G06F 17/30; G06N 5/02

(52) U.S. Cl. 707/737; 707/E17.002

(57) ABSTRACT

Methods, systems, and computer program products are used for classifying data using a collision free hash table. In an example, a respective category index for each of a set of categories is determined. A respective class counter for each of the categories based on the respective category index is generated. A respective event index for each of a set of events associated with captured data based on respective first event values are determined substantially simultaneously in parallel. Selected ones of the respective class counters based on the respective event indices are incremented substantially simultaneously in parallel.

### BACKGROUND

1. Field

Embodiments of the present invention are related to classifying data, for example into categories or classes. More specifically, certain embodiments relate to classifying data, such as events from biological sample analyzers including flow cytometer instruments, based on thresholds or gates. Certain embodiments apply to using at least partially parallel processing to perform the processing of the large amounts of data, including the at least partial parallel processing of captured data such as captured flow cytometry data.

2. Related Art

As hardware capabilities increase, researchers, statisticians, diagnosticians, clinicians, and others are demanding more sophisticated applications software that processes larger and larger amounts of data as quickly as possible. For example, users may interact with multidimensional graphs showing terabytes of data to aid data analysis. These users demand rapidly responding user interfaces and fast data displays because slow response times hinder data analysis speed and productivity.

In a specific example of a system which generates large amounts of data, consider a biological sample analyzer, such as a flow cytometer instrument. Flow cytometers are widely used for clinical and research use. A biological mixture may comprise a fluid medium carrying a biological sample such as a plurality of discrete biological particles, e.g., cells, suspended therein. Biological samples can include blood samples or other types of samples having a heterogeneous population of cells. Information obtained from the biological particles is often used for clinical diagnostics and/or data analyses.

Flow cytometry is a technology that is used to simultaneously measure and analyze multiple parameters (e.g., physical characteristics or dimensions) of particles, such as cells. Flow cytometry includes techniques for analyzing multiple parameters or dimensions of samples. Parameters (e.g., characteristics, properties, and dimensions) measurable by flow cytometry include cellular size, granularity, internal complexity, fluorescence intensity, and other features. Some parameters may be measurable after adding a marker. For example, fluorochrome-conjugated antibodies may emit photons of light in an identifiable spectrum upon excitation of the fluorochrome. Detectors are used to detect forward scatter, side scatter, fluorescence, etc. in order to measure various cellular properties. Cellular parameters identified by flow cytometer instruments can then be used to analyze, identify, and/or sort cells.

In traditional flow cytometry systems, a flow cytometer instrument is a hardware device used to pass a plurality of cells singularly through a beam of radiation formed by a light source, such as a laser beam. A flow cytometer instrument captures light that emerges from interaction(s) with each of the plurality of cells as each cell passes through the beam of radiation.

Currently available flow cytometry systems may include three main systems, i.e., a fluidic system, an optical system, and an electronics system. The fluidic system may be used to transport the particles in a fluid stream past the laser beam. The optical system may include the laser that illuminates the individual particles in the fluid stream, optical filters that filter the light before or after interacting with the fluid stream, and detectors (e.g., having photomultiplier tubes) that detect the light beam after the light passes through the fluid stream to detect, for example, fluorescence and/or scatter. The electronic system may be used to process the signal generated by the photomultiplier tubes or other detectors, convert those signals, if necessary, into digital form, store the digital signal and/or other identification information for the cells, and generate control signals for controlling the sorting of particles. The data point having the parameters corresponding to the measurement of one cell or other particle is termed an event. In traditional flow cytometry systems, a computer system converts signals received from detectors such as light detectors into digital data that is analyzed.

Flow cytometry systems capture large numbers of events from passing thousands of cells per second through the laser beam. Captured flow cytometry data is stored so that statistical analysis can subsequently be performed on the data. Typically, flow cytometers operate at high speeds and collect large amounts of data. Statistical analysis of the data can be performed by a computer system running software that generates reports on the characteristics (i.e., dimensions) of the cells, such as cellular size, complexity, phenotype, and health. Polychromatic flow cytometry refers to methods to analyze and display complex multi-parameter data from a flow cytometer instrument. Polychromatic flow cytometry data may include many parameters. Many conventional flow cytometry systems depict this data as series of graphs such as dot plots, tree plots, and/or histograms to aid operator analysis of the data.

In the case of histograms and tree plots, each event may be classified or “classed” according to certain attributes of the event. Because of the large number of events typically processed, the classification process may take a significant amount of time, slowing analysis and frustrating users.

### SUMMARY

Accordingly, what are needed are methods and systems that allow for the rapid classification of data.

Methods, systems, and computer program products for classifying data using a collision free hash table are disclosed. In an embodiment, a respective category index for each of a plurality of categories is determined. A respective class counter for each of the plurality of categories based on the respective category index is generated. A respective event index for each of a plurality of events associated with captured data based on respective first event values are determined substantially simultaneously in parallel. Selected ones of the respective class counters based on the respective event indices are incremented substantially simultaneously in parallel.

In another embodiment, an apparatus includes a first memory, a second memory, and a plurality of processors configured to share the second memory. In one example, the first and second memory may be partitioned portions of a single memory device. Each processor is further configured to control the display of captured data by determining a respective category index for each of a plurality of categories, generating a respective class counter for each of the plurality of categories based on the respective category index, determining, substantially simultaneously in parallel, a respective event index for each of a plurality of events associated with captured data based on respective first event values; and incrementing, substantially simultaneously in parallel, selected ones of the respective class counters based on the respective event indices.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments of present invention and, together with the description, further serve to explain the principles of the invention and to allow for a person skilled in the relevant art(s) to make and use the invention.

FIG. 1 illustrates a simplified exemplary flow cytometer.

FIG. 2 shows a flowchart illustrating an exemplary simplified flow cytometry data analysis process.

FIG. 3A shows a flowchart illustrating an exemplary plot generation process for creating a dot plot.

FIG. 3B shows a flowchart illustrating an exemplary plot generation process for creating a histogram or tree plot.

FIG. 4A illustrates an exemplary two dimensional dot plot graph, which may be used to display flow cytometry data.

FIG. 4B illustrates an exemplary histogram graph having a logarithmically scaled axis.

FIG. 4C illustrates an exemplary tree plot graph.

FIG. 5 shows a flowchart illustrating an exemplary gating process.

FIG. 6 illustrates an exemplary parallel computer system.

FIG. 7 illustrates an exemplary multiprocessor.

FIG. 8A shows a table illustrating exemplary gate identifiers and gates.

FIG. 8B shows a table illustrating exemplary categories, category gate value strings, and category indices.

FIG. 8C shows a table illustrating exemplary categories, category gate value strings, and category indices.

FIG. 8D shows a table illustrating exemplary gate identifiers and gates.

FIG. 8E shows a table illustrating an exemplary category, category gate value string, and category index.

FIG. 9 shows a table illustrating an exemplary set of flow cytometry data.

FIG. 10A shows a flowchart illustrating a process to establish certain exemplary data structures.

FIG. 10B shows a flowchart illustrating an exemplary shift table generating process.

FIG. 10C shows a flowchart illustrating an exemplary category index generating process.

FIG. 10D shows a flowchart illustrating an exemplary index generating process.

FIG. 11A shows a flowchart illustrating an exemplary parallel flow cytometry process.

FIG. 11B shows a flowchart illustrating an exemplary parallel gating process.

FIG. 12A shows a flowchart illustrating an exemplary data classification process.

FIG. 12B shows a flowchart illustrating an exemplary event classifying process.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### DETAILED DESCRIPTION

### Overview

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Although embodiments are applicable to any system or process for classifying various types of data, for brevity and clarity a flow cytometry environment is used as an example to illustrate various features of the present invention.

### Example Environment

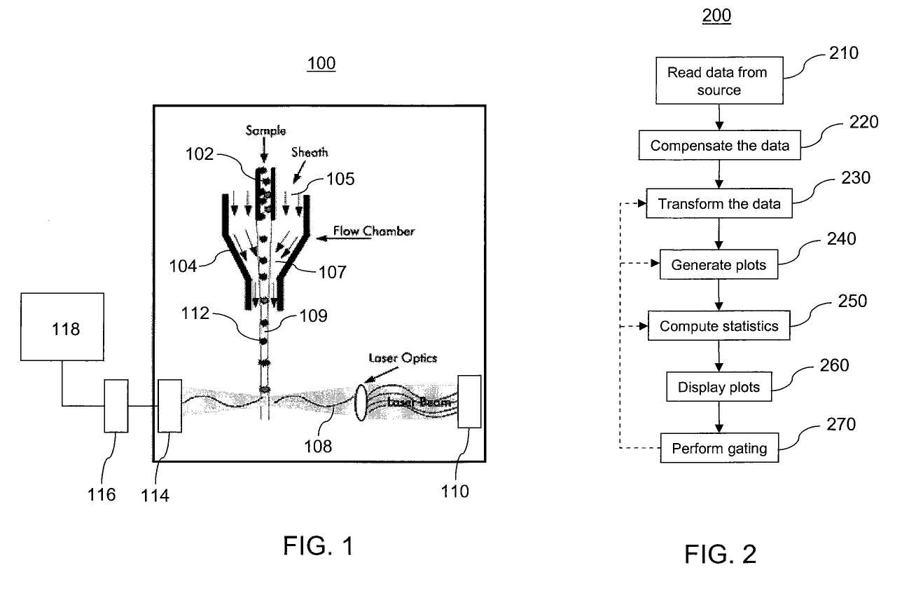

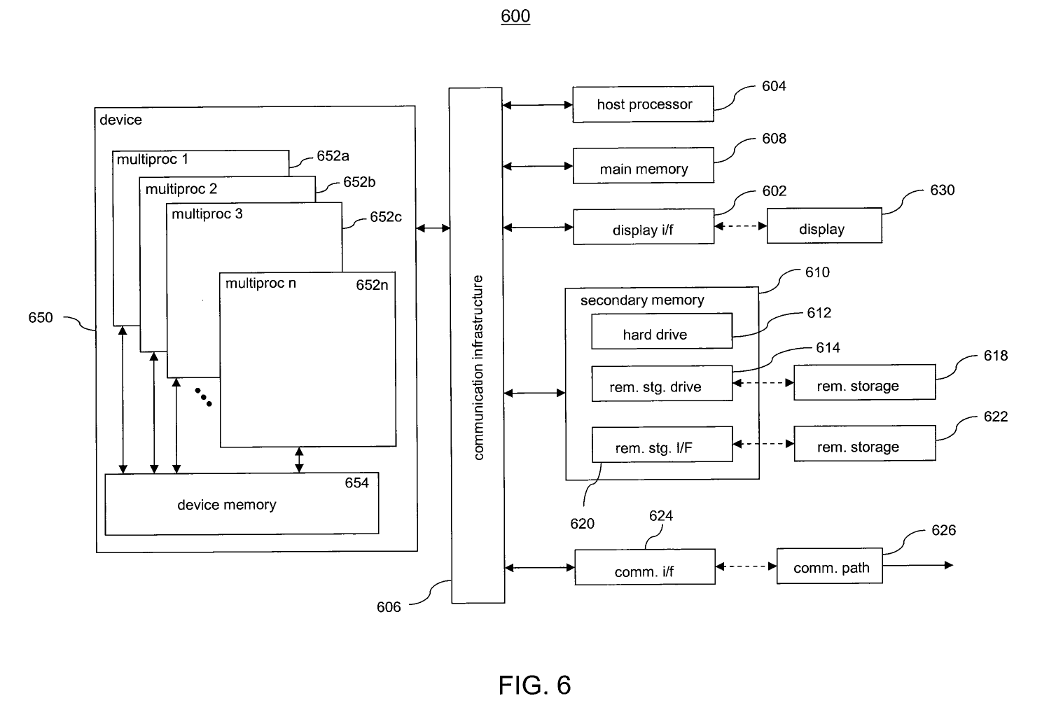

FIG. 1 illustrates an operation of a simplified exemplary flow cytometer 100. Flow cytometry uses the principles of, for example, light scattering, light excitation, and emission of photons from fluorochrome molecules to generate specific multi-parameter data from particles and cells. A biological mixture 102 containing a sample of particles 112, such as cells, is injected into the center of a sheath flow 105 contained in a flow chamber 104. The combined flow 107 is reduced in diameter, forcing each particle 112 into the center of a stream 109. A beam 108 of light, such as laser light, is generated by a light source 110. Beam 108 is directed through stream 109. As particles 112 enter beam 108, they may scatter light and any fluorochromes present may be excited to a higher energy state. The excited fluorochromes' energy is released as a photon of light with specific spectral properties unique to each fluorochromes. Detectors 114 detect at least one or both of the scattered and fluorescent light to convert them to electrical pulses or signals. In one example, the signals or pulses are received and may be amplified and/or converted to digital values using receiver 116. These digital values may be sent to a processing subsystem 118. In an embodiment, a processing system 118 includes a parallel computer system as discussed below in reference to FIG. 6.

Thus, flow cytometry data includes a set of values for various parameters for respective cells (or other particles). In one example, the set of values (i.e., event values) associated with each cell (or other particle of interest) is termed an “event.” Thus event values include the measured parameter values for the event. Other event values include information associated with the event, such as event gate values as described below. For example, the measured parameters include fluorescent energy emitted at particular wavelengths and scatter (e.g., front scatter and side scatter) intensities. Each event can have a number, N, N being a integer greater than or equal to 0, of measured parameter values associated with it, and may be thought of as a point in N dimensional space. In a typical flow cytometer sample, several million events are measured and recorded for analysis. Flow cytometry data may be analyzed after the fact (e.g., read from a data file) or it may be analyzed in substantially real-time, as a sample is passing through the instrument. As used herein, the term “serial processing” means using non-parallel processing. “Parallel processing” includes partial and completely parallel processing. Embodiments of the invention may be used in parallel processing environments and/or serial processing environments. Some embodiments may be used in and/or include flow cytometry systems. Some of these embodiments may be used in and/or include parallel flow cytometry systems.

### Flow Cytometry

FIG. 2 shows a flowchart illustrating an exemplary simplified flow cytometry data analysis process 200. The steps may be performed in any order or concurrently unless specified otherwise. Some embodiments of the present invention do not require the performance of each and every step.

In step 210, captured data is read from a source. As discussed elsewhere herein, the source may be a file or database, or may be immediately stored after being collected from a sample.

In step 220, the data is compensated. In one example, compensation removes spectral overlap introduced during data collection. In an embodiment, compensation includes solving a system of linear equations. Because the flow cytometry data can be viewed as an M×N matrix of M events and N parameters, where M and N are integers equal or greater than 0, compensation may be performed using a matrix multiplication operation. In this example, the M×N data matrix is multiplied by an N×N compensation-matrix. The N×N matrix includes coefficients defining the proportion of a corresponding parameter to be removed from other parameters. In some implementations, matrix multiplication is an O(n³) operation.

In step 230, the data is transformed. In one example, transformation scales the data for display. When viewing a displayed graph (e.g., on a screen or printed page), the range of the data can reduce the effectiveness of the display. For example, a parameter may have a range of possible parameter values from 0 to 1,000,000, but a data set may have actual values in the range of 100 to 500. Thus, displaying the full scale axis on a 100 pixel square dot plot would force the entire data set to a single pixel row or column. Thus, the data needs to be transformed to provide a viewer with an accurate representation. In various examples, parameter values may be transformed to a linear scale or a logarithmic scale. Linear transformation may be performed by computing a new parameter value from the original parameter value using the equation y=a*x+b, where x is the old value, y is the new value, and a and b are constants. Logarithmic transformation may be performed by computing a new parameter value form the original parameter value using the equation y=b*log (a*x), where x is the old value, y is the new value, a and b are constants, and log is a logarithm of any base. In one example, all of the events in the data are sequentially or serially traversed for the particular parameter to be transformed resulting in an O(n) operation, where n is the number of events.

In step 240, plots are generated, for example plots for a graphical representation of the data to be shown on a display through a graph or through a hard copy output. There are various types of plots that may be generated. For example, dot plots, density plots, and other plots may be generated by scanning the data set are scanned to determine the pixel corresponding to the parameter value(s) of each event being drawn. In histograms, tree plots and certain other plots, the data set is scanned and the requisite counters are incremented. Example tree plots and user interactions with tree plots are described in more detail in U.S. Patent Appl. No. [To Be Assigned], Atty. Docket No. 2512.2340000, to Zigon, et al., which is incorporated by reference herein in its entirety. The counters may be visualized by drawing bars (e.g., “leaves” in a tree plot) of corresponding heights. Generation of some of these types of plots is described in more detail herein.

In step 250, statistics are generated. For example, a user may desire to measure various statistics, such as mean, median, mode, standard deviation etc. to describe the data. Statistics may be measured on the entire data set or on sub-populations (e.g., median value of parameter x for all the events inside gate A).

In step 260, plots and/or statistics are displayed. For example, plots and/or statistics may be displayed on any media (e.g., computer screen, printed on paper, etc.) for the user. Although display of the data for analysis is an important use of flow cytometry systems, some embodiments of the invention herein are not concerned with the display of the data per se, but in the underlying processing, determination, decisions making, and/or calculations resolving various aspects of the displaying of the data. Thus, when discussing determining a pixel or pixel value, the term pixel and pixel value refers to not only a potential specific location on a display, but also a corresponding memory location or other storage area. Further, an attribute such as shape may be used to convey information to the viewer. In that case, a pixel would not be a pixel in the ordinary sense of the term, but instead would be a discrete location on a display, where the location may include more than one pixel in the ordinary sense.

In step 270, gating is performed. Gating is discussed in detail elsewhere herein. In this step, the user may manipulate graphical displays of gates (e.g., click and drag or otherwise draw a gate on a displayed graph or plot) or use any other method of describing a gate to the system, including having default gates. Additionally, or alternatively, after completion of the gating process, process 200 may return back to any one of step 230, 240, and/or 250 to re-transform the data, re-generate the plots, and/or re-compute statistics. These steps may be repeated for all data or only for the data affected by the gating.

Thus, according to one or more embodiments, the flow cytometry processes described herein allow the user to iteratively analyze the data by selecting and/or modifying the types of graphs displayed and the variables, axes, and/or gates of interest.

### Plot Generation

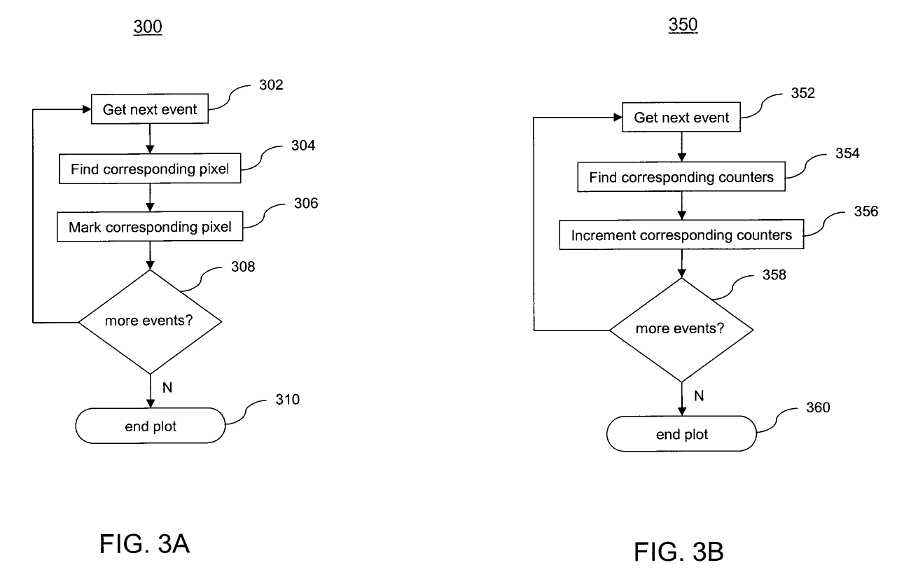

FIG. 3A shows a flowchart illustrating an exemplary plot generation process 300 for creating a dot plot. For example, process 300 can be used as step 240 in FIG. 2. The steps may be performed in any order or concurrently unless specified otherwise. Some embodiments of the present invention do not require the performance of each and every step.

In step 302, an event or a next event is retrieved (e.g., accessed) and/or received. For example, data corresponding to an event is received or accessed.

In step 304, a corresponding pixel is determined for the received or retrieved or accessed event. In this step, the parameter values of the event are used to determine a corresponding pixel. For example, the parameter values corresponding to the parameters associated with axes of the dot plot are examined and the corresponding location on the dot plot is determined. As discussed above, the term pixel as used throughout this application means not only a pixel on a computer screen display, but a discrete location on any display media, and also encompasses an associated memory location or storage location. If an attribute, such as shape, is used to convey information to the viewer, a pixel would not be a pixel in the ordinary sense of the term, but instead would be a set of pixels representing a discrete location or area on a display, such that it may include more than one pixel in the ordinary sense. Thus, this step may include determining the location on the graph to which the event maps and an associated memory location.

In step 306, the corresponding pixel is marked. For example, a value is assigned to the pixel based on the parameter values of the event. This step is discussed in detail below.

In step 308, a determination is made whether there are more events to be plotted. If yes, then process 300 returns to step 302. If no, then process 300 proceeds to step 310.

In step 310, plotting is complete.

FIG. 3B shows a flowchart illustrating an exemplary plot generation process 350 for creating, for example, a histogram or tree plot. For example, process 350 can be used for step 240 in FIG. 2. The steps may be performed in any order or concurrently unless specified otherwise. Some embodiments of the present invention do not require the performance of each and every step.

In step 352, an event or a next event is retrieved (e.g., accessed) and/or received. For example, data corresponding to an event is received, retrieved or accessed.

In step 354, corresponding counters are determined, for example using the parameter values of the event. For example, the parameter values corresponding to a gate are examined and a counter associated with the gate is located. In another example, a parameter value associated with a histogram variable or axis is located along with an associated counter depending on a parameter value of the event.

In step 356, the corresponding counter is incremented. For example, the counters used in step 354 are incremented depending on the parameter value(s). For example, if a gate found in step 354 is satisfied, the associated counter is incremented. Additionally, or alternatively, this step may be combined with step 354 (e.g., locate and increment the counter in one step). The performance of steps 354 and 356 may be collectively called “classifying” an event, as the events are being classified into each category. Thus a class counter is a term that refers to a counter that is incremented when an event is determined to belong to the associated category/class.

In step 358, a determination is made whether there are more events to be plotted. If yes, then process 350 returns to step 352. If no, then process 350 proceeds to step 360.

In step 360, plotting is complete.

### Graphs and Gates

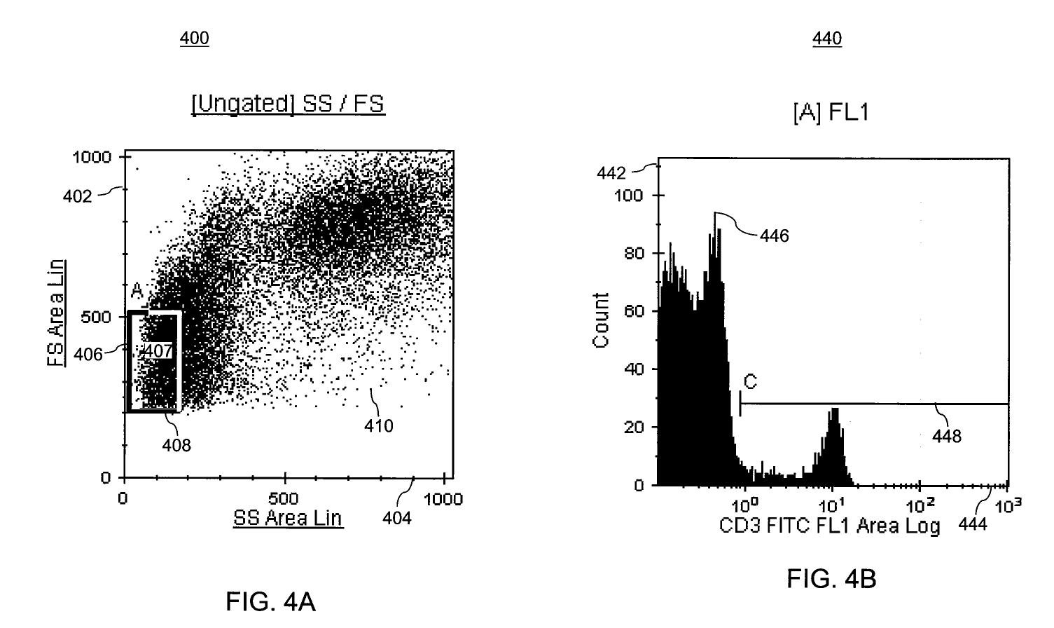

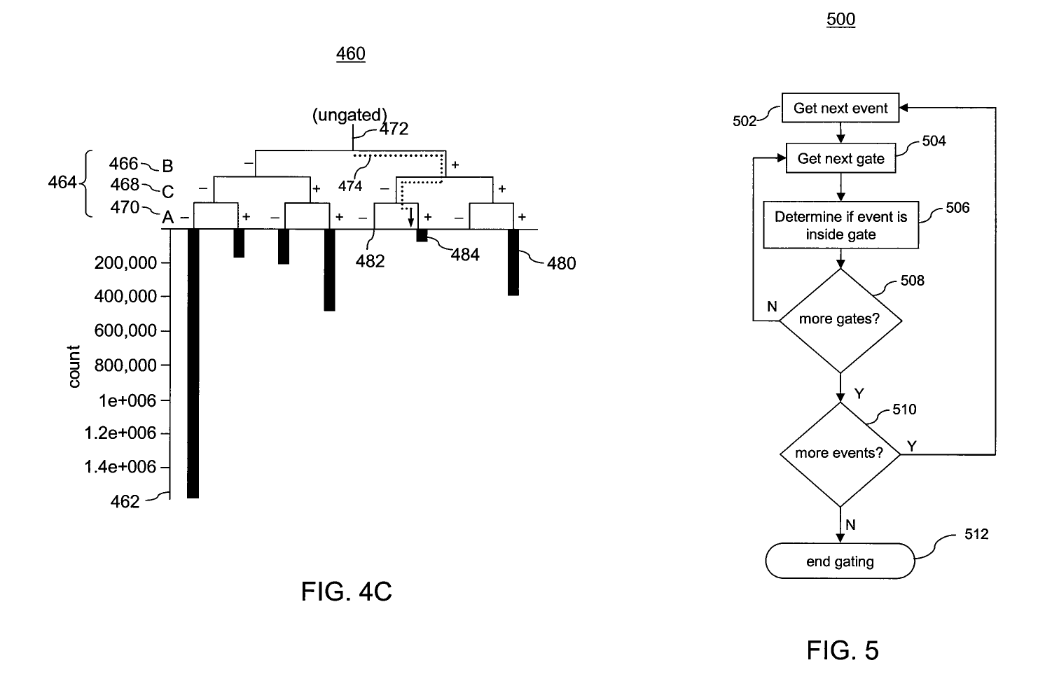

FIG. 4A illustrates an exemplary two dimensional graph 400, e.g., a dot plot, which may be used to display flow cytometry data. In the example shown, dot plot 400 has an X axis 404 scaled to show side scatter values between about 0 and 1,000 and a Y axis 402 scaled to show front scatter values between about 0 and 1,000. In various examples, the scales of the X axis 404 and/or the Y axis 402 may be linear as shown or logarithmic.

In this example, events 410 having X and Y values within the scales of X axis 404 and Y axis 402 are displayed on dot plot 400. However, events may also be excluded from display based on whether they satisfied certain gates. In one example, each event 410 may have more than two parameter values, however only the parameter values corresponding the parameters associated with X axis 404 and Y axis 402 determine the location or pixel where event 410 is displayed. For the sake of simplicity, the location where event 410 is displayed will be referred to as a pixel, however, this is not intended to limit the display of data such as dot plot 400 to a particular media. For this example, pixel will be used throughout this document as to describe a discrete location on a graph and an associated memory location storing a value or values associated with that discrete location on the graph.

An exemplary two dimensional gate 407 is shown on dot plot 400 of FIG. 4A, defined by a first side 406 and a second side 408. Some events 410 are inside gate 407, other events 410 are outside gate 407. In one example, the use of the terms “inside a gate” and “satisfy a gate” is interchangeable. In one example, a gate may have one or more dimensions. For example, gate 407 is shown having two dimensions: first side 406 defines a Y dimension and second side 408 illustrates an X dimension. In various examples, each gate may be described by any algebraic and/or Boolean combination of, for example, gate values, gate variables, gate conditions, and gate operators. Gate variables can correspond to parameters measured for each event. Gate values may describe limits for the gate variables. Gate conditions may be relational operators, such as less than (“<”), greater than (“>”), etc. Gate operators may be Boolean operators, such as “AND” and “OR.” The two-dimensional, rectangular gates shown are merely used as simple examples to aid comprehension, but other embodiments are not limited to this example. Because gates may be described by any combination of, for example, gate values, gate variables, gate conditions, gate operators, gates may be any regular or irregular shape. Gates may include any Boolean and/or algebraic construction involving any number of parameters (gate variables). Further, gates may include more than two variables and may not be displayable on a two dimensional plot. A user may define a gate using a graphical user interface (e.g., drawing or click/drag gate boundaries) or by any other method (e.g., typing in a gate description) or any other method including default gates.

In this example, gate 407 may be expressed as “(200<FS Area<510) AND (180>SS Area).” Thus “FS Area” and “SS Area” are gate variables, numbers “200,” “510,” and “180” are gate values, symbols “<” and “>” are gate conditionals, and “AND” is a gate operator. Events with parameter values that satisfy gate 407 may be displayed inside gate 407. Thus, an event with FS Area=300 and SS Area=100 is inside gate 407. Of course, if gate 407 were instead equivalent to the expression “NOT(200<FS Area<510) OR (180<SS Area),” the events 410 circumscribed by gate 407's boundaries, such as the example event with FS Area=300 and SS Area=100, would be outside gate 407, and the remaining events would be inside gate 407.

Gates may include gate variables corresponding to parameters, which are not displayed on a currently visible dot plot. For example, event 410 includes parameter values corresponding to the FS Area parameter and the SS Area parameter. It may also have parameter values corresponding to other parameters w, x, y, and z. Thus, a gate may be defined that may be expressed as “(125<w) AND (445<x<489) OR (z>500)” and event 410 may be inside (or outside) the gate even though the gate is not visible. However, for ease of description, gates are often discussed in conjunction with a display showing the gate.

FIG. 4B illustrates an exemplary histogram 440 having a gate 448. Gate 448 is a one-dimensional gate (e.g., “FITC FL1 Area>10⁰”). Histogram 400 has an X axis 444 logarithmically scaled to show CD3 FITC FL1 Area values from approximately 10⁻¹ to 10³. Histogram 440 also has a Y axis 442 linearly scaled to show a count value from approximately zero to 110. Histogram 400 includes a plurality of bars 446 having a constant width. In this example, the bar widths are relatively narrow and appear almost as lines. Other histograms may have variable-width bars 446. In this example, each bar 446 represents a number of events having a CD3 FITC FL1 Area value falling within a region along X axis 444 defined by the width of the bar 446. In other words, histogram 440 represents a frequency distribution illustrated by bars 446, each bar having a width representing a class interval and having a height representing the number of events falling into the class.

FIG. 4C illustrates an exemplary tree plot 460 having an axis 462 linearly scaled to show counts ranging from approximately 0 to 1,600,000. In one example, tree plot 460 may be generated by the processes described elsewhere herein. Tree plot 460 also includes a gate hierarchy 464 comprising levels 466, 468, and 470. Level 466 includes gate B, level 468 includes gate C, and level 470 includes gate A. Gate hierarchy 464 defines branches, such as an exemplary branch 474. Each branch extends from a root 472 to one of a plurality of leaves, such as leaf 480. Branch 474 extends from root 472 to leaf 484. A leaf may have a length zero, such as leaf 482. In tree plot 460, each leaf represents a number (count) of events residing in a category defined by a branch (e.g., branch 474). Thus in this example, leaf 480 represents approximately 400,000 counts in a corresponding category. Leaf 484 represents approximately 70,000 counts in a corresponding category defined by branch 474. Leaf 482 represents 0 counts in a corresponding category. Example tree plots and user interactions with tree plots are described in more detail in U.S. Patent Appl. No. [To Be Assigned], Atty. Docket No. 2512.2340000, to Zigon, et al., which is incorporated by reference herein in its entirety.

Throughout this document, the notation “+” when placed next to a gate means inside the gate, and “−” when placed next to a gate means outside the gate. In tree plot 460, the inside (“+”) path is always to the right and the outside (“−”) path is always to the left. When reading a gate hierarchy, each branch follows a “+” or a “−” at each level to define the category represented by the leaf at the end of the branch. For example, branch 474 may be read as follows: at level 466, branch 474 follows the “+” path for gate B; at level 468, branch 474 follows the “−” path for gate C; and at level 470, branch 474 follows the “+” path for gate A. Thus, the category delineated by leaf 482 and defined by branch 474 may be described as “B+C−A+,” which translates to inside of gate B, outside of C and inside of A. An event is considered to be within this category only if it meets all three of those conditions. In tree plot 460, leaf 484 indicates that approximately 70,000 events were classified in category “B+C−A+” in this example. Throughout this document, the statement that an event “belongs” to a category means that the event should be classified into that category. Similarly, an event is classified when it is determined to which category the event belongs and an associated class counter is incremented. In other words, of the events measured and classified in the sample, roughly 70,000 were inside of gate B, outside of gate C, and inside of gate A, and thus belonged to the category “B+C−A+.” Similarly, leaf 480 indicates that approximately 400,000 events belonged to category “B+C+A+” in this example. It is important to note that each event will belong to one and only one category as the categories describe every possible inside/outside combination of the gates. The following sections describe exemplary methodologies and systems which may be used to classify and count events and generate plots such as tree plot 460.

### Gating Process

FIG. 5 shows a flowchart illustrating an exemplary gating process 500. For example, process 500 can be performed for step 270 in FIG. 2. The steps may be performed in any order or concurrently unless specified otherwise. Some embodiments of the present invention do not require the performance of each and every step.

In step 502, an event or a next event is retrieved, accessed, and/or received. For example, data corresponding to the event is received, accessed, or retrieved in this step.

In step 504, a gate or a next gate is retrieved, accessed, and/or received. For example, information corresponding to a gate is received, accessed, or retrieved.

In step 506, the event is compared to the gate to determine whether the event is inside the gate. For example, this can be done as discussed throughout the application.

In step 508, a determination is made whether there are more gates to be processed. If yes, then process 500 returns to step 504. If no, then process 500 proceeds to step 510.

In step 510, a determination is made whether there are more events to be processed. If yes, then process 500 returns to step 502. If no, then process 500 proceeds to step 512.

In step 512, gating is complete.

### Parallel Flow Cytometry

Embodiments of the invention may be used in and/or include a serial (non-parallel) processing environment or in a parallel processing environment. For example, certain embodiments of the invention apply to and/or include the parallel processing architectures: Single Instruction Multiple Data (SIMD), Single Process Multiple Data (SPMD), and/or Single Instruction Multiple Thread (SIMT). Flow cytometry analysis is particularly suited to architectures such as these as they are particularly suited to the performance of an operation or process on a large number of data points. The following description describes an example parallel processing architecture for flow cytometry. This architecture is used merely as an example to describe various features of the invention. In various examples, this may be optimized through use of a multiple-processor chip, such as a graphical processing unit, instead of or in addition to a single or dual processing chip, such as a more traditional central processing unit. For example, a graphics card as manufactured by nVIDIA of Santa Clara, Calif. or by ATI/AMD of Sunnyvale, Calif. may be used as described below as a device 650.

Example embodiments, such as those using an nVIDIA GPU having 128 Processing Elements (e.g., certain 8800 series products), using the techniques herein may process five million event-parameters of captured data (e.g., captured flow cytometry data) in less than 5 seconds, preferably less than 2 seconds and most preferably less than 1 second. One hundred million to one billion (preferably at least 500 million, most preferably at least 750 million) event-parameters may be processed in less than 30 seconds, preferably less than 15 seconds and most preferably less than 5 seconds. Event parameters are the number of events multiplied by the number of parameters in each event. As hardware technology progresses, the performance of embodiments of this invention will continue to likewise improve. Similarly, improvements to operating systems and other software that yield general performance gains will also improve the performance of embodiments of this invention.

### Example Parallel Flow Cytometry Hardware Environment

FIG. 6 illustrates an exemplary parallel computer system 600 useful for implementing certain embodiments of the invention. For example, the present invention, or portions thereof, can be implemented as computer readable code in parallel computer system 600. For example, the methods illustrated by processes 200, 300, 350, 500, 800, 1000, 1020, 1040, 1060, 1100, 1150, 1200, and 1220 of FIGS. 2, 3A, 3B, 5, 8, 10A-10D, 11A-11B, and 12A-12B can be implemented in system 600. Various embodiments of the invention are described in terms of this example parallel computer system 600. After reading this description, it will become apparent to a person skilled in the relevant art how to implement the invention using other computer systems and/or computer architectures.

Parallel computer system 600 includes a display interface 602. Connected to the display interface may be display 630. Display 630 may be integral with a flow cytometer system or it may be a separate component. Parallel computer system 600 includes one or more processors, such as host processor 604. Host processor 604 can be a special purpose or a general purpose processor. Host processor 604 is connected to a communication infrastructure 606 (for example, a bus, or network).

Parallel computer system 600 also includes a main memory 608, preferably random access memory (RAM), and may also include a secondary memory 610. Secondary memory 610 may include, for example, a hard disk drive 612, a removable storage drive 614, flash memory, a memory stick, and/or any similar non-volatile storage mechanism. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into parallel computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to parallel computer system 600.

Parallel computer system 600 may also include a communications interface 624. Communications interface 624 allows software and data to be transferred between parallel computer system 600 and external devices. Communications interface 624 may include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

Parallel computer system 600 also includes at least one device 650. Device 650 is coupled to rest of parallel computer system 600, including host processor 604, via communication infrastructure 606. Device 650 comprises a plurality of multiprocessors 652a-652n, where n is an integer having a value of 0 or higher. Each multiprocessor 652 may have a SIMD architecture, as described in detail elsewhere herein. The device 650 also includes a device memory 654, coupled to each multiprocessor 652a-652n.

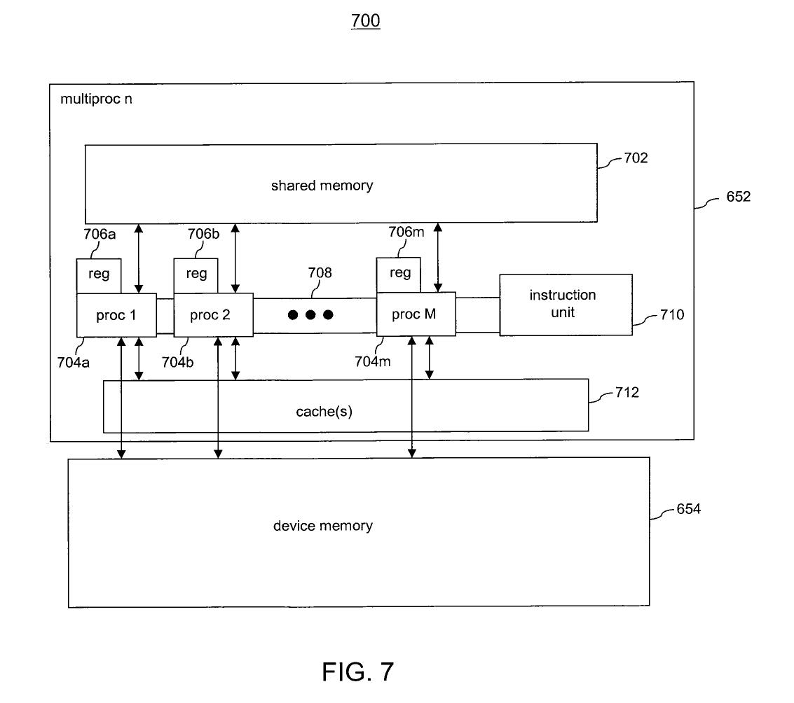

FIG. 7 illustrates an exemplary multiprocessor 652 which may be used in device 650. Multiprocessor 652 includes a plurality of processors 704a-704m, where m is an integer having a value of 0 or higher. Each processor 704 is coupled to or includes a set of local registers 706. Processors 704a-704m are coupled to each other and to an instruction unit 710 via a communications path 708. Processors 704a-704m are also coupled to a shared memory 702, a cache 712, and device memory 654. In an embodiment, at least a portion of cache 712 is read-only and provides faster reads than device memory 654. Shared memory 702 is typical faster than device memory 654 but may be smaller than device memory 654.

During operation, multiprocessor 652 may map one or more threads to each processor 704a-704m. Threads of execution, or simply threads, are simultaneous (or pseudo-simultaneous, such as in a multitasking environment) execution paths in any serial or parallel computer. Some threads may execute independently and/or cooperate with other threads. In some parallel architectures, threads may execute on different processors and/or share data (e.g., use shared memory).

For example, in the Compute Unified Device Architecture (CUDA), all threads of a thread block reside on the same processor core, but multiple thread blocks are scheduled in any order across any number of processor cores. The NVIDIA CUDA Compute Unified Device Architecture Programming Guide, Version 2.0 of Jun. 7, 2008, is incorporated by reference herein in its entirety. The number of threads per thread block is limited by the resources available to each processor core. For example, on the NVIDIA Tesla hardware implementation of CUDA, a thread block is limited to 512 threads. Thread blocks are split into warps. Each warp is a set of parallel threads (e.g., 32 threads). A half-warp is the first half or the second half of a warp. Individual threads of a warp start together at the same program address, but may branch and execute independently. Warps are executed one common instruction at a time. If threads of a warp diverge due to a conditional branch, then the threads are serially executed until the threads converge back to the same execution path.

CUDA allows a programmer to define functions, called kernels. Typically a program running on a host such as host processor 604 invokes a kernel. When invoked, a kernel may be executed on a device, such as device 650 illustrated in FIG. 6 by one or more thread blocks. Therefore, the number of total threads is equal to the number of blocks times the number of threads per block. The programmer may synchronize the execution of the threads in a block by defining synchronization points using a synchronize threads function. All threads of the block wait until all the threads of the block reach the synchronization point before proceeding.

### Example Parallel Flow Cytometry Process-Introduction

Transitioning a wholly serial or sequential cytometry process to an at least partial parallel environment, such as parallel computer system 600 presents several challenges. For example, memory access speeds have not increased proportionally with processor speeds. In some parallel architectures, a memory access may require an order of magnitude more clock cycles than a floating point operation. Memory accesses in those architectures should be minimized. Also, different types of memory accesses take different amounts of time. For example, a shared memory access (e.g., accessing shared memory 702) may take one or more orders of magnitude less time than a device memory access (e.g., accessing device memory 654). Taking these challenges into account, transitioning a serial or sequential flow cytometry data processing method to a parallel environment is not a straightforward process. Many innovative techniques are required to maximize the capabilities of the specific architecture. For example, consider generating a dot plot in a parallel environment. If each thread simply reads the data it needs to process an event and finds and marks corresponding pixel, the amount of time spent performing memory operations may be several hundred times the amount of time spent performing computations.

In another example, consider the generation of a tree plot such as exemplary tree plot 460 illustrated in FIG. 4C and described above. A tree plot illustrating classified events based on n gates (where n is a positive integer) will have 2ⁿ distinct categories. For example, tree plot 460 illustrates the classification of events based on three gates (B, C, and A) and thus has eight categories. In a non-parallel environment, a process might sequentially consider each event and compare it against each category until the category to which the event belongs is found, resulting in up to 2ⁿ comparisons for each event. As described above, gates can be complex combinations of gate values, gate variables, gate conditions, gate operators, including any Boolean and/or algebraic construction involving any number of parameters (gate variables). Thus, each comparison of a gate to an event may be complex and potentially includes multiple calculations and comparisons. Performing 2ⁿ comparisons, with an n of any appreciable size, for each of several million events may result in unacceptable processing times.

Parallel processing capabilities may be applied to reduce the total processing time. One exemplary process reduces total processing time by creating a thread for each event. Each thread compares the event against each of the 2ⁿ categories until the category to which the event belongs is found. This approach may be faster than the non-parallel process described above, but each thread still makes a significant number of comparisons. Further, a thread might determine the category to which its event belongs before some of the other threads (i.e., on one of the first comparisons). Therefore, many threads complete their categorization task and are idle during a significant amount of the total processing time.

The following sections describe exemplary embodiments using, for example, hash table solutions that reduce the number of comparisons, thus accelerating the processing speed and reducing the time threads wait for other threads to complete classification of their events.

### Example Parallel Flow Cytometry Process—Data Structures for Hash Tables

A discussion of exemplary data structures that allow for the implementation of this embodiment using exemplary hash table solutions is discussed below. In an embodiment, each gate has a unique gate identifier associated with the gate. A gate identifier may be string of values (e.g., bits). In a further embodiment, the gate identifier for each gate encodes an assigned priority of the gate. For example, a gate identifier may be a bit string having a binary value equal to 2ⁿ+1, where n is the priority of the gate and n is an integer greater than zero. Thus, if gate 1 is priority 1, its gate identifier would be “0 . . . 00000011” (i.e., a plurality of “0” bits followed by two “1” bits. If gate 2 is priority 2, its gate identifier would be “0 . . . 00000101.” If gate 5 is priority 5, its gate identifier would be “0 . . . 00100001.” It is not necessary to prioritize the gates as long as each gate is assigned a unique number. Furthermore, other encoding schemes are possible. In an embodiment, a higher priority number represents a higher priority, but that need not be the case. For example, priority 5 may be either higher or lower priority than priority 1 depending on the priority convention used in a particular embodiment.

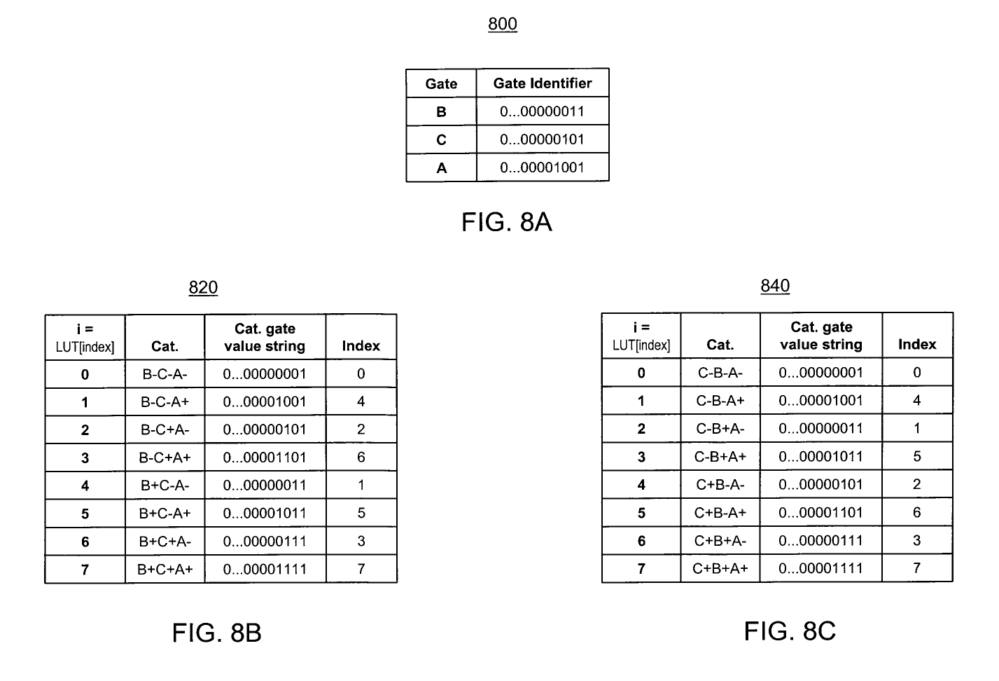

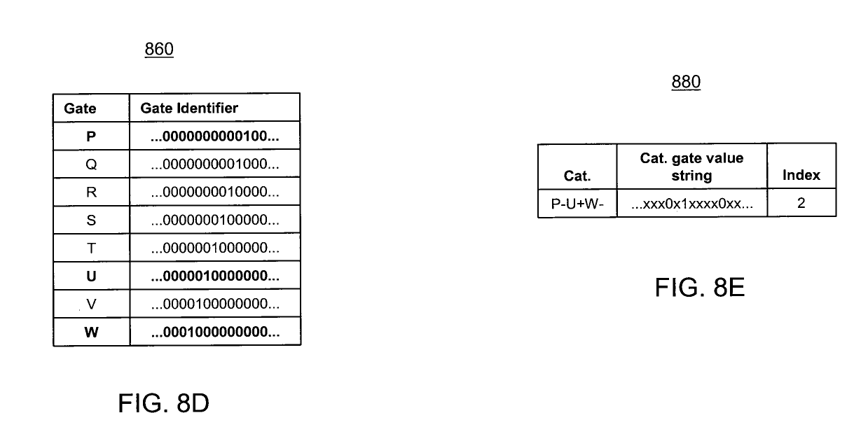

FIG. 8A illustrates table 800 showing an exemplary assignment of gate identifiers to gates. These gate identifiers are for illustration purposes only and will be used for the following discussion.

FIG. 8B illustrates an exemplary table 820 showing an exemplary assignment of category gate value strings to categories based on the gate identifiers illustrated in table 800. A category gate value string encodes the combination of satisfied and unsatisfied gates defining an associated category. In an embodiment, a category gate value string encodes the satisfied gates of the associated category. Category gate value strings may comprise a series of category gate values. In an embodiment, each category gate value is a bit. There are eight example categories in table 820. Each category is assigned an index. A category index provides a short, unique index value for referencing a particular category. Category indices may be calculated in various ways. For example, the indices in exemplary table 820 may be determined by calculating the decimal value of the of the category gate values string, while ignoring the rightmost bit.

In an embodiment, the order of the categories in table 820 reflects the order of the gates in the levels of a gate hierarchy of a tree plot. For example, with reference to tree plot 460 illustrated in FIG. 4C tree plot 460 includes a gate hierarchy 464 comprising levels 466, 468, and 470. Level 466 includes gate B, level 468 includes gate C, and level 470 includes gate A. In this example embodiment, the categories shown in table 820 are in the same order as tree plot 460. A Look Up Table (LUT) may be constructed taking advantage of this order. In an embodiment, a LUT is a one dimensional array of index values ordered based on the levels of a gate hierarchy. Thus, the LUT is a hash table and a hashing function is used to map values (e.g., category gate values) to the table. The value “i” in table 820 represents the order of the categories in a tree plot (e.g., tree plot 460) from left to right. In an embodiment, the order of the entries in a LUT is such that the x^{th} element in the LUT holds the value i, where×is the index. In the example illustrated in table 820, an exemplary LUT array would include the elements {0, 4, 2, 6, 1, 5, 3, 7} (i.e., LUT[index]=i). It is to be appreciated that the Index column in table 820 coincidentally includes the same series as the LUT because of the example categories and gate identifiers used. The following provides an example that does not.

In one example, a purpose of the LUT is to dynamically map the category indices to the categories displayed in a tree plot, such as tree plot 460. It is to be appreciated that if the order of the gates assigned to the levels of a gate hierarchy is changed, the indices of each category do not change in value, but are reordered in the LUT. For example, consider exemplary table 840 as illustrated in FIG. 8C. In this example, a gate hierarchy has been reordered compared to table 820 in FIG. 8B, such that gate C is on the highest level, followed by gate B and then gate A. Because the order of the gates in the category do not change the logical properties of the category (e.g., C−B−A− is equivalent to A−B−C−), the events which belong to each equivalent category will not change. Further, the category gate value strings will not change for equivalent categories, as illustrated in table 840. For example, C+B−A− in table 840 is equivalent to B−C+A− in table 820, thus both have the category gate value string 0 . . . 00000101. Because the category gate value strings are the same and this example uses the same process to calculate the indices, the corresponding indices are the same. For example, the category gate value string 0 . . . 00000101 results in an index value of 2 in both tables. However, the order of the categories has changed from table 820 to table 840. Thus a corresponding exemplary LUT defined by table 840 using the i=LUT[index] relation results in a LUT array equal to {0, 2, 4, 6, 1, 3, 5, 7}. Note that the LUT has changed order from the LUT as defined by table 820. Thus, if a user changes the order of tree plot gates, the events do not have to be re-gated. Also, the Index column no longer contains the same series of numbers as the LUT.

In an embodiment, not all of the gates are required to be used when classifying events. More generally, not all of the category gate values may be important to the current classification process, i.e., not all category gate values are “interesting” values, e.g., biologically significant values or values of interest in the current analysis. In the example illustrated in FIGS. 8A-8C, only three gates are used and only three bits (the fourth through the second from the right) of the category gate value strings are interesting. The rest may be discarded or safely ignored. For example, these are uninteresting category gate values because they are always the same value. The interesting category gate values in this example are adjacent. However, in other embodiments of the invention, the interesting category gate values might not be adjacent as illustrated in the following example.

FIG. 8D illustrates a table 860 showing another exemplary assignment of gate identifiers to gates. These gate identifiers are for illustration purposes for the following discussion. Among the assigned gates are gates P through W. The section of each gate identifier shown is the same section for each gate (e.g., each of these might be bits 11-23 in a 32 bit word). The gate identifiers are unique with respect to each other. The rightmost bit (not shown) may be a “1” if the exemplary 2ⁿ+1 gate identifier assignment methodology is used.

FIG. 8E illustrates an exemplary table 880 showing a single exemplary assignment of a category gate value string to one of the categories based on the gate identifiers for gates P, U, and W illustrated in table 860. In one example, a tree plot (such as tree plot 460) contains three levels having the gates P, U, and W assigned, which may be one of the eight category gate values string assignments to a category delineated by a leaf of the tree plot. In table 880, the “x” values indicate uninteresting values. If only gates P, U, and W are being used to classify the events, the interesting values are the bits that could be affected by a combination of gates P, U and W. Therefore, an index value may be assigned based on these bits only. In this example, the interesting bits are converted into a decimal value to determine the index value. It is to be appreciated that the other seven categories formed by the combinations of the P, U, and W gates will similarly form unique indices of values ranging from 0 to 7. Thus, the interesting category gate values may be used and the uninteresting values may be safely ignored, which allows for compressing the category gate value string and decreasing of the amount of processing required. It is to be further appreciated that in this example, the existence or nonexistence of gates other than P, U, and W does not affect the determination of index values when uninteresting values are ignored. For example, although gates Q, R, S, etc. are shown in table 860 of FIG. 8D, the assignment of a category gate value string and the calculation of an index as shown in table 880 would be unaffected if unused gates Q, R, S, etc. and their gate identifiers were never defined in the first place.

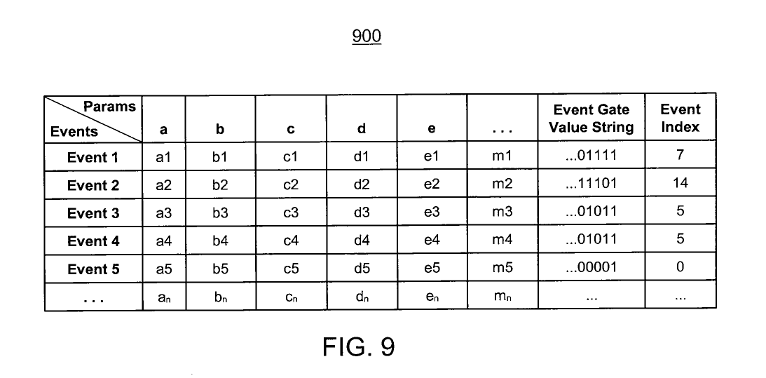

FIG. 9 shows table 900 illustrating a set of flow cytometry data. In flow cytometry, a data point having parameter values corresponding to the measurement of one cell or other particle is termed an event. Thus, the flow cytometry data set may be viewed as an M×N matrix of M events having N parameters, N and M being integer values greater than 0. In one embodiment of the present invention, each event also has an event gate value string. An event gate value string is plurality of event gate values (e.g., bits), wherein each event gate value corresponds to a defined gate and the event gate value itself (e.g., 0 or 1) indicates whether the event satisfies the corresponding gate. An event gate value string may be considered an event value itself. Flow cytometry data may be visualized as table 900 as illustrated in FIG. 9. A number of events (N) are represented, each having a number of parameter values (M). The parameters shown are a, b, c, d, and e. Parameter values a1, a2, etc. indicate an actual measured value of each parameter for that event. Each event also has an associated event gate value string, which need not be stored contiguously to parameter values of the event. In an embodiment, each event gate value string is a string of bits as shown in table 900.

As discussed above, gate identifiers are unique identifiers associated with each gate. In an exemplary embodiment where gate identifiers are unique bit strings. For example, a gate identifier may be a bit string having a binary value equal to 2ⁿ+1, where n is the priority of the gate. Thus, if gate 1 is priority 1, its gate identifier would be “0 . . . 0000001” (i.e., a plurality of “0” bits followed by two “1” bits. If gate 2 is priority 2, its gate identifier would be “0 . . . 00000101.” If gate 5 is priority 5, its gate identifier would be “0 . . . 00100001.” Other encoding schemes are possible. Gating an event may be performed (whether in a wholly serial or sequential or at least partially parallel environment) by performing a bitwise OR of the satisfied gate identifiers and the event gate value. For example, an event gate value string may be initialized to “0 . . . 0000000.” If it is determined that the associated event satisfies gate 1, the event gate value string is bitwise ORed with gate 1's identifier. The resulting event gate value string is “0 . . . 00000011.” If the event is then determined to satisfy gate 5, the event gate value string is bitwise ORed with gate 5's identifier. The resulting event gate value string is “0 . . . 00100011.” Thus, according to this embodiment of the present invention, the gates satisfied by the event are encoded in the event gate value string. The event indices shown may be calculated in the same manner as the category indices described above. Thus, the LUT is a hash table and a hashing function is also used to map event values (e.g., event gate value strings) to the table. For example, the event gate value string, or just the interesting bits of the event gate value string, may be converted to a decimal number. As discussed with respect to category gate values above, uninteresting event gate values in event gate value strings may be safely ignored, effectively compressing the event gate value strings and reducing the amount of processing.

### Example Parallel Flow Cytometry Process—Creating Data Structures

The preceding exemplary data structures demonstrate a property that is used for efficiently classifying events. In one example, an event may be compared to each and the results of the comparisons may be encoded into a gate value string of the event. Once the event has been compared to each gate, the event index, which depends upon the event gate value string, may be generated. The event belongs to the category having a matching index. The event index does not need to be compared to the category indices at all, rather the event index can be used to directly (or indirectly) reference and increment a counter associated with the category. The following discussion elaborates on methods and systems for efficiently classifying data using attributes of the example data structures discussed above. Although the example data structures are used in some of the following exemplary processes and systems, it is to be appreciated that other specific data structures have similar properties and could be used.

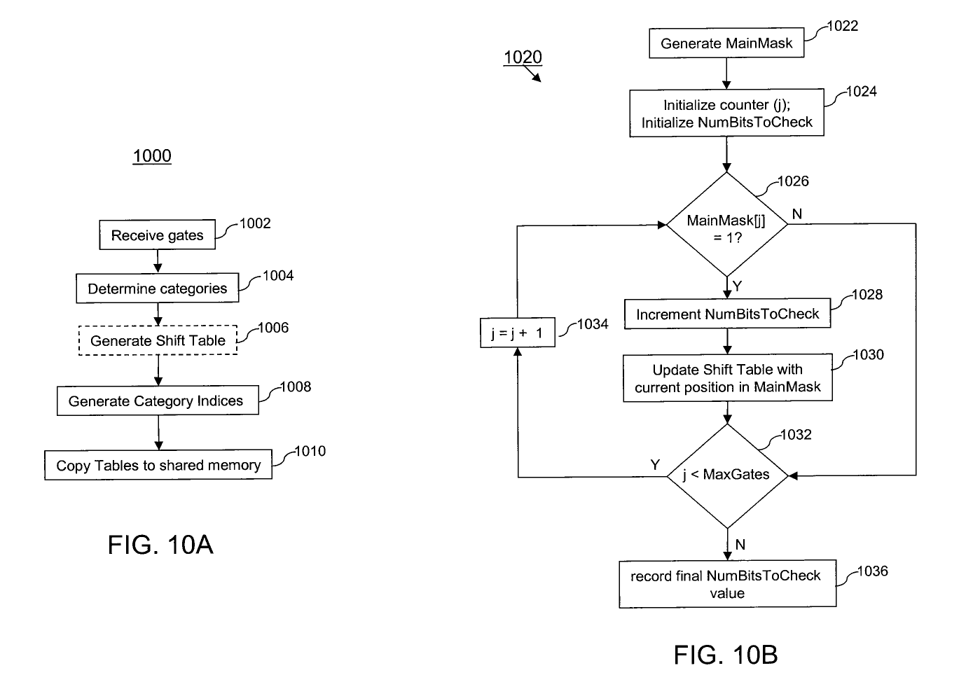

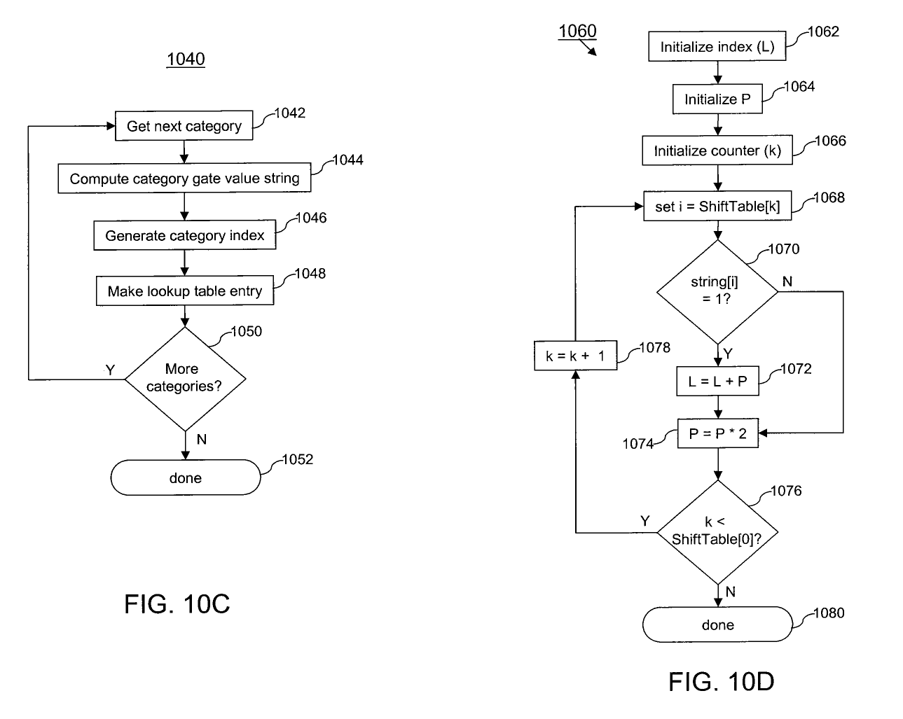

FIG. 10A shows a flowchart illustrating an exemplary process 1000 to establish certain data structures that may be used and allow for efficient data classification. For example, process 1000 could be used to establish certain data structures to allow for the parallel processing of flow cytometry data, such as that described below. This process 1000 is useful for understanding certain embodiments of the present invention. The steps may be performed in any order or concurrently unless specified otherwise. Some embodiments of the present invention are applicable to the process 1000 illustrated in the flowchart. Some of these embodiments do not require the performance of each and every step.

In step 1002, a set of gates is received, retrieved, and/or accessed. As described above, gates can be, for example, complex combinations of gate values, gate variables, gate conditions, gate operators, including any Boolean and/or algebraic construction involving any number of parameters (gate variables). In an embodiment, gate identifiers are assigned in this step. In another embodiment, gate identifiers are received along with the gates.

In step 1004, categories are determined. In an embodiment, 2ⁿ categories are defined using the n gates received in step 1002, where n is a positive integer. The determined categories are defined by the possible combinations of the gates received in step 1002.

In optional step 1006, a shift table is generated. The purpose of this optional step is to allow for the efficient compression of event gate value strings and category gate value strings by ignoring the uninteresting category gate values and event gate values. In an embodiment where step 1006 is not performed, each value of the value strings is processed. Interesting and uninteresting values are discussed above with reference to tables 820 and 840 of FIGS. 8A and 8B and table 900 of FIG. 9. In an embodiment, a shift table includes an indication of the number of gates received in step 1002 and an indication of the location of the interesting gate values in event gate value strings and category gate value strings. For example, a shift table may comprise a first value indicating the number of interesting gate values in each event and/or category gate value string. A shift table may further comprise a series of location values wherein each location value provides an absolute or relative position of each interesting gate value in a category or event gate value string. For example, a shift table comprising {4, 1, 3, 5, 7} may indicate that each category and event gate value string has four (as indicated by the first number) interesting values at absolute positions 1, 3, 5, and 7. That is, the first interesting value is in bit position 1, the second is in bit position 3, the third is in bit position 5 and the fourth is in bit position 7. In another example, the positions may be relative. In that case, this shift table would indicate that each category and event gate value string has four interesting values. The first interesting value is in bit position 1, the second is in bit position 4 (3+1), the third is in bit position 9 (5+4) and the fourth is in bit position 16 (7+9) example method for creating a shift table is discussed below in reference to process 1020 as shown in FIG. 10B.

In step 1008, category indices are generated. For example, category indices according to one embodiment are described in detail above in reference to tables 800, 820, 840, 860, and 880 as shown in FIGS. 8A-8E. An example method of performing this step is described in detail below with reference to process 1040 illustrated in FIG. 10C. In an embodiment, a LUT is generated and populated in this step. For example, LUTs according to one embodiment are described above in to tables 800, 820, 840, 860, and 880 as shown in FIGS. 8A-8E.

In step 1010, tables are copied to memory, for example a shared memory. In embodiments using an architecture having a shared memory or equivalent, this step is performed to provide the thread or threads performing the classification of the data rapid access to the category indices. If a LUT is generated in step 1008 above, the LUT is copied to the shared memory. In an embodiment using or including a computer system 600 as described above with reference to FIG. 6, steps 1002-1008 may be performed by the host processor, and the table (e.g., LUT) is transferred to shared memory (or memories) for use by threads running on device 650.

FIG. 10B shows a flowchart illustrating an exemplary process 1020 for generating a shift table. In an embodiment, process 1020 may be used to perform step 1006 described above in process 1000 and shown in FIG. 10A. The steps may be performed in any order or concurrently unless specified otherwise. Some embodiments do not require the performance of each and every step.

In step 1022, a MainMask is generated. For example, a MainMask indicates which positions of the event gate value strings and category gate value strings can be safely ignored, i.e., which positions will contain interesting values and which positions will contain uninteresting values, as discussed above. In an embodiment, a MainMask is generated by performing a bitwise OR of each gate identifier for the gates of interest in the current classifying process. Referring back to FIG. 8D showing table 860, it is to be appreciated that the bitwise ORing of the gate identifiers for gates P, U, and W would result in an exemplary MainMask including “. . . 0001010000100 . . . .” which indicates the positions of the interesting bits of the category gate value string shown in table 880 of FIG. 8E. In other words, this example string has “1” values at the positions of the interesting gate values in category gate value string 880.

In step 1024, a counter (j) and NumBitsToCheck are initialized. In an embodiment, the counter and/or NumBitsToCheck are initialized to zero.

In steps 1026-1034 described below, the MainMask generated in step 1022 is traversed and the number of interesting bits (e.g., ‘1’ bits) are counted and the locations of the interesting bits are recorded in a shift table.

In step 1026, a determination is made whether the value in the j^{th} slot of the MainMask generated in step 1022 is “1”. For example, if the j^{th} slot has a value indicating an interesting value (e.g., a ‘1’), then process 1020 proceeds to strep 1028. If j^{th} slot does not have a “1” value, process 1020 proceeds to step 1032.

In step 1028, NumBitsToCheck is incremented.

In step 1030, a shift table is updated with the current position being examined in the MainMask. This step records in the shift table the position of the interesting value found in step 1026. In an embodiment, the relative position is stored in shift table. In an embodiment, the shift table is a one dimensional array (e.g., “ShiftTable[ ]”). The relative position may be stored in shift table by setting ShiftTable[NumBitsToCheck]=j−ShiftTable[NumBitsToCheck−1]. In another embodiment, the absolute position is stored in the shift table. The absolute position may be stored in the shift table by setting ShiftTable[NumBitsToCheck]=j.

In step 1032, a determination is made whether the MainMask has been completely traversed. For example, MaxGates may indicate a maximum number of gates and also the maximum length of a MainMask. Thus, if j<MaxGates, i.e., MainMask has not been completely traversed, process 1020 proceeds to step 1034. If j>MaxGates, i.e., MainMask has been completely traversed, process 1020 proceeds to step 1036.

In step 1034, the counter j is incremented. Thus, when process 1020 proceeds to step 1026, the next position of MainMask is examined.

In step 1036, the final value of NumBitsToCheck is recorded. In an embodiment, the first position in the Shift Table is set to the current value of NumBitsToCheck. This step records the total number of interesting bits, e.g., the number of “1” values in MainMask, which has been counted by NumBitsToCheck. It is to be appreciated that in an embodiment, NumBitsToCheck was incremented prior to its use as an array index for Shift Table in step 1030. Thus ShiftTable[0] remains unused until the performance of this step.

FIG. 10C shows a flowchart illustrating an exemplary process 1040 for generating category indices. In an embodiment, process 1040 may be used to perform step 1008 described above in process 1000 and shown in FIG. 10A. The steps may be performed in any order or concurrently unless specified otherwise. Some embodiments do not require the performance of each and every step.

In step 1042, a category or the next category is retrieved, accessed, or received.

In step 1044, a category gate value string is determine or calculated for the category. For example, one embodiment of category gate value strings are described above especially in reference to FIGS. 8A-8E. In an embodiment, category gate value strings are formed by performing a bitwise OR of the gate identifiers of the satisfied gates of the category. For example, for an exemplary category A+B+C−D−E+, the category gate value string could be formed by performing a bitwise OR of the gate identifiers for gates A, B, and E. The bitwise OR operation may be performed successively on each gate, e.g., an initialized category gate value string may be bitwise ORed with gate A, then the result bitwise ORed with gate B, and then that result bitwise ORed with gate E.

In step 1046, a category index is generated. For example, one embodiment category indices are described above in reference to FIGS. 8A-8E. A category index provides a reference to its associate category. In an embodiment, a category index encodes the satisfied and/or unsatisfied gates of the category. In a further embodiment, a category index encodes a category gate value string. For example, a category index may be a decimal value of some or all of the category gate value string. The portions of the category gate value string that may not need to be encoded may be indicated by a shift table, for example as described above in reference to step 1030. For example, a process for performing this step is described in detail below in reference to process 1060 shown in FIG. 10D. In another example, a process is shown in pseudocode immediately following the description of process 1060. It is to be appreciated that other processes may be used to perform this step.

In step 1048, an entry in a lookup table (LUT) is made. For example, a LUT as described above in the description of FIGS. 8A-8E may be used.

In step 1050, a determination is made if there are any more categories for which category indices are to be generated. If yes, then process 1040 proceeds to step 1042. If no, process 1040 proceeds to step 1052.

In step 1052, process 1040 is done.

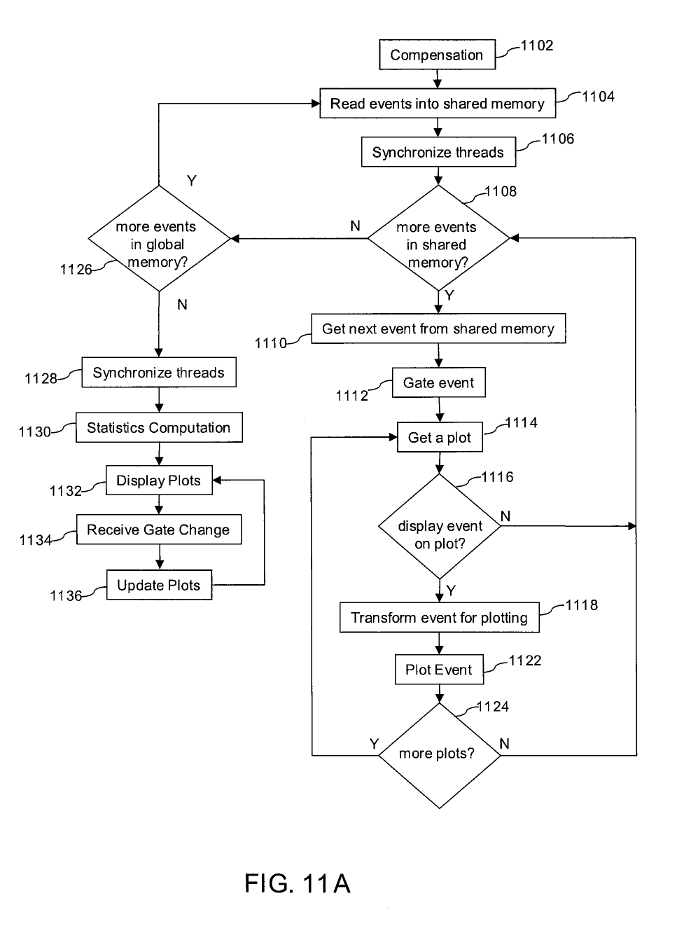

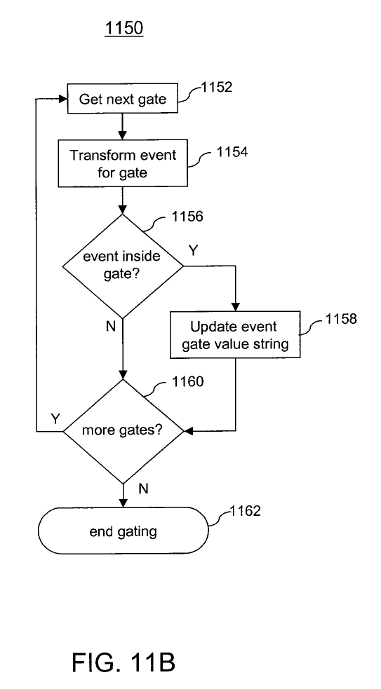

FIG. 10D shows a flowchart illustrating an exemplary process 1060 for generating an index (e.g., a category index or an event index). In one example, process 1060 may be used to perform step 1046 of process 1040 shown in FIG. 10C. In another example, process 1060 may be used to perform step 1120 of process 1100 illustrated in FIG. 11A. The steps may be performed in any order or concurrently unless specified otherwise. Some embodiments do not require the performance of each and every step.

In step 1062, an index (L) is initialized. In an embodiment, L is an integer variable greater than or equal to 0. In a further embodiment, L is initialized to a value of 0.

In step 1064, a variable P is initialized. In an embodiment, P is an integer variable greater than or equal to 1. In a further embodiment, P is initialized to a value of 1.

In step 1066, a counter k is initialized. In an embodiment, k is an integer variable greater than or equal to 0. In a further embodiment, k is initialized to a value of 1.

In step 1068, a variable i is set to the k^{th} value in a shift table. In an embodiment, the shift table has values indicating the absolute position of interesting gate values in category and/or event gate value strings. For example, the above descriptions of step 1006 of process 1000 and step 1030 of process 1020 may be used.

In step 1070, a determination is made whether the i^{th} value of a gate value string (e.g., a category gate value string or an event gate value string) is set to a value (e.g., “1”). If yes, then process 1060 proceeds to step 1072. If no, then process 1070 proceeds to step 1074.

In step 1072, the index (L) is updated by adding value P to L.

In step 1074, P is updated by multiplying by two. In an embodiment, this multiplication step is performed by left shifting the value P by one bit.

In step 1076, a determination is made whether the total number of interesting values have been parsed and accounted for. In an embodiment, this step is performed by comparing k to the total number of interesting values in a gate value string (e.g., category gate value string or event gate value string). In a further embodiment, this step is performed by determining whether k is less than the 0^{th} value in the shift table—in that embodiment, the first value of the shift table contains the total number of interesting values. See, for example, the description of step 1036 of process 1020 above and shown in FIG. 10B. If all of interesting values have not been parsed (e.g., k<ShiftTable[0]), then process 1060 proceeds to step 1078. If all the interesting values have been parsed (e.g., k>=ShiftTable[0]), then process 1060 proceeds to step 1080.

In step 1078, the counter k is incremented.

In step 1080, process 1060 is done.

It is to be appreciated that process 1060 illustrates an example process for determining an index. Other example processes may also be used. For example, the following pseudocode illustrates another example process for determining an index. In an embodiment, the process illustrated by the following pseudocode may be used to perform step 1046 of process 1040 shown in FIG. 10C and described above. In another example, process 1060 may also be used to perform step 1120 of process 1100 illustrated in FIG. 11A. The process illustrated by the following pseudocode is useful for understanding certain embodiments of the present invention. Some embodiments of the present invention are applicable to the process illustrated in the following pseudocode:

```
int Compute_Index(unsigned int eMask, int ShiftTable[ ])
{
    int Index=0;
    int pow=1;
    for (int i=0; i< ShiftTable[0]; i++)
        {
        eMask =eMask >> ShiftTable[i+1];
        Index = Index + (eMask & 0x00000001) * pow;
        pow = pow <<1;
        }
    return Index;
}
```

In the above pseudocode, eMask represents a gate value string (e.g., category gate value string or event gate value string) sent to the function Compute_Index. ShiftTable[ ] is an array of values where the 0^{th} value holds the total number of interesting values and the remaining values hold the relative positions of the interesting gate values in the gate value strings. The above descriptions of step 1006 of process 1000 and step 1030 of process 1020 describe relative positions in shift tables in detail. The “for loop” iterates for a number of times determined by the total number of interesting values (as stored in ShiftTable[0]). During each iteration of the for loop, the eMask is right shifted by the number (i.e., relative position) stored in the current slot in the ShiftTable. The Index is incremented by a power of two stored in pow—but only if the current interesting value in eMask is 1. It is to be appreciated that the number of previous iterations and thus the number of left shifts of pow determines the power of two stored in pow.

In one example, the above described processes may be performed and/or the data structures instantiated prior to and/or in conjunction with the exemplary parallel flow cytometry process in the following description.

### Example Parallel Flow Cytometry Process

FIG. 11A shows a flowchart illustrating an exemplary parallel flow cytometry process 1100 that may be implemented in parallel computer system 600. This process 1100 is useful for understanding certain embodiments of the present invention. The steps may be performed in any order or concurrently unless specified otherwise. Some embodiments of the present invention are applicable to the process 1100 illustrated in the flowchart. Some of these embodiments do not require the performance of each and every step. Reference back to the description of a wholly serial or sequential flow cytometry processing, and the description of FIG. 2, may help the reader understand the at least partially parallel process described below.

In step 1102, compensation is performed. Compensation in general is described with reference to step 220 of process 200 as illustrated by FIG. 2. Compensation may be performed in parallel. In an embodiment, parallel compensation is performed in a separate function, e.g., a separate kernel in a CUDA environment, from the other main cytometry steps (e.g., transformation, plot generation, gating, statistics generation). Parallel compensation may be performed as a parallel matrix multiplication step performed by a plurality of threads.

In step 1104, compensated events are read into shared memory (e.g., shared memory 702). For example, a set of threads may be used to read the compensated events into shared memory 702 at least partially in parallel. In an embodiment, shared memory 702 is not large enough to store all of the compensated events. In this case, a subset of the compensated events are read into one or more shared memories 702. In a further embodiment, steps 1104-1126 are repeated until all events have been read into shared memory and processed. Additionally, or alternatively, the data read performed in this step may be coalesced to optimize the read and avoid memory bank conflicts according to the specific system architecture.

For example, in a CUDA architecture, global memory access (e.g., access to a portion of device memory 654) by a half warp of sixteen threads may be coalesced into one or two memory transactions if it satisfies three conditions: (a) the threads access sixteen 32 bit words (one transaction of 64 bytes), sixteen 64 bit words (one transaction of 128 bytes), or sixteen 128 bit words (two transactions of 128 bytes each), (b) all sixteen words accessed lie in the same segment and that segment has the same size as the one or two transactions, and (c) the threads access the words in order (e.g., the third thread accesses the third word). Therefore, in an example flow cytometry embodiment implemented in a CUDA environment, each thread of a half warp reads a corresponding parameter of the events (e.g., thread 1 reads the values for parameter 1 of the events, thread 2 reads the values for parameter 2 of the events), etc. If each parameter value is stored in a word, then each memory transaction may read 16 parameters. Once read, the event data may be stored in shared memory (e.g., shared memory 702) in such a manner as to avoid shared memory bank conflicts, regardless whether the read was coalesced.

In CUDA, shared memory is divided into equally sized shared memory banks. A shared memory bank conflict occurs if multiple, simultaneous memory reads or writes are attempted to addresses in a single shared memory bank. In other words, shared memory reads or writes to several addresses can be performed simultaneously as long as each address is in a separate bank. If shared memory reads or writes attempt to access more than one address in a bank at the same time, a shared memory bank conflict results and the read or write is broken into as many reads or writes as necessary to be conflict-free. Shared memory banks in CUDA are organized such that successive 32 bit words are assigned to successive banks. Thus, memory reads or writes of multiple words to successive banks do not result in a conflict and may occur simultaneously.

Therefore, in an embodiment, event data is stored in shared memory (e.g., shared memory 702) in columns—that is, each parameter for the set of events is stored in an specific shared memory bank (e.g., parameter 1 of the events is stored in shared memory bank 1, parameter 2 in shared memory bank 2, etc.).

In step 1106, threads are synchronized. For example, each thread delays until the other threads that are executing one or more of the previous step(s) have reached the synchronization point. After all the threads have reached this synchronization point, the threads may proceed to step 1108, executing independently. For example, in CUDA, the execution of the threads in a block may be synchronized at defined synchronization points using a synchronize threads function. All threads of the block delay until all the threads of the block reach the synchronization point before proceeding.

In step 1108, a determination is made whether there are more events in shared memory to process, or whether all events in the shared memory (e.g., shared memory 702) have been processed. If there are more events in shared memory to process, process 1100 moves to step 1110. If all events in shared memory have been processed, process 1100 moves to step 1126. In one example, step 1108 allows for a set of threads to perform in parallel to process a larger number of events at a same time and/or faster than is possible when doing serial or sequential processing. For example, if there are 10 threads and 100 events, step 1108 may allow the 10 threads to process in parallel until all 100 events are processed, which can allow for 10× increase in processing speed as compared to serial processing since all 10 are processing at the same time on the 100 events, rather than sequentially or serially. In an embodiment, this step and steps 1108-1126 are performed in a separate operation from the other general flow cytometry steps (e.g., compensation and statistics generation). For example, in an embodiment, the transformation, the gating, and the plotting may be combined into one CUDA kernel. Thus, each block of threads will read a portion of the event data into shared memory and perform the processing required to perform these three general flow cytometry steps on that portion of event data. This reduces the amount of memory reads required to slower global memory (e.g., a portion of device memory 654).

In step 1110, each thread accesses, retrieves, or receives a next event from shared memory, such as shared memory 702. For example, the event currently being processed by a thread is termed its current event.

In step 1112, each thread gates its current event. For example, as discussed above, gating an event includes determining which gates are satisfied by the event by comparing the event (its parameter values) to the gate. An exemplary process for parallel gating which is discussed in with below respect to FIG. 11B. In an embodiment, each thread updates and/or creates an event gate value string for its current event.

In step 1114, each thread gets a plot. In an embodiment, each thread accesses certain parameters regarding a plot, for example, a dot plot that is to be displayed.

In step 1116, each thread makes a determination whether its current event is to be plotted on the current plot. If no, process 1100 may return to step 1108. Even if the current event is not to be plotted, however, process 1100 may proceed to step 1116. If yes, process 1100 proceeds to step 1116. In an embodiment, plots may be designated to show only events that are inside of (or outside of) one or more gates. For example, if the current plot is designated to display only plots inside of gate G, each thread may examine its event to determine whether the event is inside of gate G. In an embodiment, each thread examines its event's gate value string to determine whether its event is inside and/or outside each of the gates designated for the current plot. In another embodiment, each thread may examine its event to ensure its event is within the scale of the plot.

In step 1118, each thread transforms its current event for plotting. Transformation is described in detail elsewhere herein (e.g., see description of step 230 of flowchart 200).

In step 1122, each thread plots its event. In an embodiment, each thread determines a counter that maps to its current event. In an embodiment, the counter is incremented. The process of finding corresponding counters is sometimes referred to as classifying data (e.g., events) as the process is analogous to segregating items based on their characteristics and placing them in distinct classes. In an embodiment, a thread examines parameter values for a current event corresponding to the parameters associated with the each gate. Based on those parameter values, the thread determines which counter should be updated. In another embodiment, each thread uses an event gate value string associated with its event to determine the counter to be updated. In a further embodiment, an event index is determined. In one example, an event index may be determined by the same processes that can be used to determine a category index. For example, process 1060 as illustrated in FIG. 10D and described above may be used to determine an event index. In another example, the pseudocode described above may be used to determine an event index. In a further embodiment, counters associated with each category may be incremented using a Look Up Table (LUT), as described above and illustrated in FIGS. 8A-8E. For example, the correct counter may be identified and incremented using the following pseudocode statement: “counter[LUT[index]]++;” where index is the event index.

In step 1124, each thread determines whether there are any more plots to process for its current event. If yes, process 1100 returns to step 1114. If no, process 1100 returns to step 1108. In one example, step 1124 allows each thread to work through a set of plots that are being generated and update any pixels and/or counters associated with each plot that map to a current event of the thread. In embodiments where plots such as dot plots are generated, events are mapped to pixels. However, for simplicity and brevity, this example process details the generations of plots such as tree plots that update counters.

Again, if the determination in step 1108 is that there are no more events, process 1100 proceeds to step 1126. In step 1126, a determination is made whether there are any more events in global memory to process, or whether all events in the global memory (e.g., a portion of device memory 654) have been processed. If there are more events in global memory to process, process 1100 moves to step 1104. If all events in global memory have been processed, process 1100 moves to step 1128.

In step 1128, threads are synchronized. Threads delay until other threads executing the previous step(s) have reached this synchronization point. For example, in CUDA, the execution of the threads in a block may be synchronized at defined synchronization points using a synchronize threads function. In this example, all threads of the block delay until all the threads of the block reach the synchronization point before proceeding.

In step 1130, statistics computation is performed. Statistics generation in general is described in the discussion of step 250 of process 200 above. Statistics generation may be in parallel. In an embodiment, parallel statistics generation is performed as a separate function (e.g., a separate CUDA kernel) from the other main cytometry steps (e.g., compensation, transformation, plot generation, and gating). Parallel statistics generation may be performed by a plurality of threads.

In step 1132, plots and statistics may be displayed as described in the discussion of step 260 of process 200 above.

In step 1134, a change to a gate may be received. For example, a user may modify a gate using a graphical user interface (e.g., clicking and dragging or re-drawing a gate boundary) or by any other method (e.g., typing in a gate description). Additionally and/or alternatively, a user may update the categories displayed in the tree plot (e.g., change which levels are displayed). For example, tree plots and user interactions with tree plots are described in more detail in U.S. Patent Appl. No. [To Be Assigned], Atty. Docket No. 2512.2340000, to Zigon, et al., which is incorporated by reference herein in its entirety.

In step 1136, plots are updated. In this step, plots which may have events that could have been affected by the changed gate are re-determined. For example, in an embodiment, if only the categories are changed (i.e., no gates are changed), then a look up table (LUT) may be used to dynamically map categories and associated class counters to the displayed categories in a plot, such as a tree plot, as described above with reference to FIGS. 8A-E. If the gates are changed, a process similar to that described above may be used to re-evaluate each event and corresponding counter. Process 1100 returns to step 1132 to display the updated plots.

As discussed above in “Example Parallel Flow Cytometry Process—Data Structures for Hash Tables” and “Example Parallel Flow Cytometry Process—Creating Data Structures,” gate identifiers are unique identifiers associated with each gate. In an embodiment, an event is gated and the gates satisfied by the event are encoded in the event gate value string, and event indices shown may be calculated in the same manner as the category indices described above. Gating an event (e.g., in step 1112 above) may be performed-whether in a wholly serial or sequential or at least partially parallel environment-by performing a bitwise OR of the satisfied gate identifiers.

FIG. 11B shows a flowchart illustrating an exemplary parallel gating process 1150, for example that may be used to perform step 1112. The steps may be performed in any order or concurrently unless specified otherwise. Some embodiments of the present invention do not require the performance of each and every step.

In step 1152, a gate or next gate is retrieved, accessed, and/or received. In an embodiment, a thread retrieves, accesses, or receives information corresponding to a gate.

In step 1154, an event is transformed for the current gate. In an embodiment, a thread transforms the event for the gate. Transformation is described in detail elsewhere herein (e.g., see description of step 230 of flowchart 200). Transformation for a gate (as opposed for a plot) similarly scales the event for the gate. In an alternative embodiment, the gate is transformed for the event, i.e., the scale of the gate is transformed to the scale of the appropriate event parameters.

In step 1156, an event is compared to the gate to determine whether the event is inside the gate. In an embodiment, the thread makes this comparison using its current event. If the event satisfies the gate, process 1150 moves to step 1158. If the event does not satisfy the gate, the process 1150 moves to step 1160.

In step 1158, a gate value string of the event is updated. In an embodiment, the updating comprises a bitwise OR operation of a gate identifier and an event gate value string. In an embodiment, the thread performs the updating.

In step 1160, a determination is made whether there are more gates to be processed. If yes, process 850 returns to step 1152. If no, process proceeds to step 1162. In an embodiment, the thread makes this determination.

In step 1162, gating is complete for the event.

### General Classification of Data Using a Collision Free Hash Table

The preceding discussion described embodiments of the present invention in a specific application. However, as discussed in the embodiments below, embodiments of the present invention can be used in many other applications.

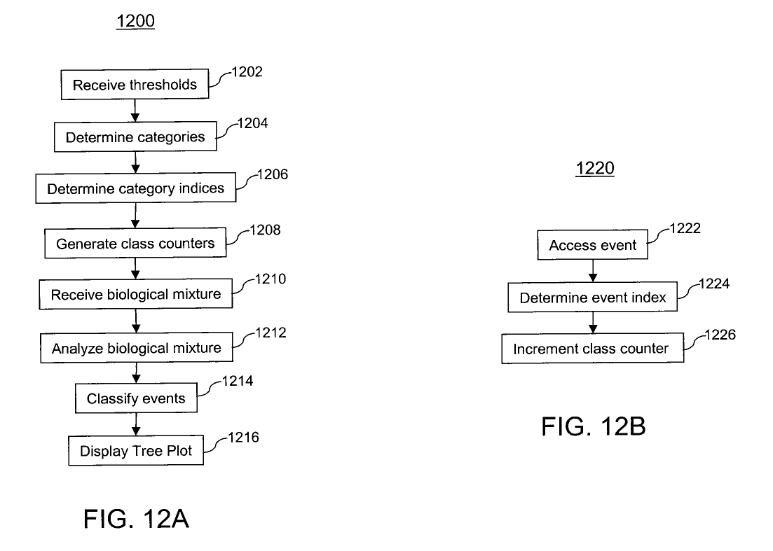

FIG. 12A shows a flowchart illustrating an exemplary data classification process 1200. The steps may be performed in any order or concurrently unless specified otherwise. Some embodiments of the present invention do not require the performance of each and every step.

In step 1202, thresholds are received, accessed, and/or retrieved. In an embodiment, the thresholds include algebraic and/or Boolean descriptions of conditions. A threshold may be identified by a threshold identifier which includes a threshold identifier value. In a further embodiment, the thresholds are gates and threshold identifiers are gate identifiers.

In step 1204, categories are determined based on the received thresholds.

In step 1206, category indices are determined. A category index provides a short, unique index value for referencing a particular category. A category index may be determined using category threshold values associated with the category. In an embodiment. In an embodiment, thresholds are gates and category threshold values are category gate values. In a further embodiment, category indices are calculated by a process described herein.

In step 1208, class counters are generated. Each class counter is associated with a category and may be accessed directly or indirectly using the category's associated category index.

In step 1210, a biological mixture is received. In an embodiment, the biological mixture includes cells and markers.

In step 1212, the biological mixture is analyzed. In an embodiment, physical characteristics of each cell are measured and recorded. This recorded data is termed captured data. In an embodiment, the captured data is from a flow cytometer.

In step 1214, events are classified. In an embodiment, captured data comprises events. Classifying events includes finding and incrementing the corresponding class counters. In an embodiment, events is classified according to process 1220 described below and illustrated by FIG. 12B.

In step 1216, a tree plot is displayed. The tree plot represents at least one of the values of the class counters.

FIG. 12B shows a flowchart illustrating an exemplary event classifying process 1220. For example, process 1220 may be used to perform step 1210 described above. The steps may be performed in any order or concurrently unless specified otherwise. Some embodiments of the present invention do not require the performance of each and every step.

In step 1222, an event is received, accessed, and/or retrieved.

In step 1224, an event index is determined. An event index provides a short, unique value corresponding to a category to which the event belongs. In an embodiment, an event index is calculated by a process described herein.

In step 1226, a class counter corresponding to the event is incremented. The class counter is identified using the event index determined in step 1224.

### CONCLUSION

In this document, the terms “computer program medium” and “computer usable medium” are used to generally refer to media such as removable storage unit 618, removable storage unit 622, and a hard disk installed in hard disk drive 612. Signals carried over communications path 626 can also embody the logic described herein. Computer program medium and computer usable medium can also refer to memories, such as main memory 608 and secondary memory 610, which can be memory semiconductors (e.g. DRAMs, etc.). These computer program products are means for providing software to parallel computer system 600.

Computer programs (also called computer control logic) are stored in main memory 608 and/or secondary memory 610. Computer programs may also be received via communications interface 624. Such computer programs, when executed, allow for parallel computer system 600 to implement the present invention as discussed herein. In particular, the computer programs, when executed, allow for host processor 604 to implement the processes of the present invention, such as the steps in the methods illustrated by processes 200, 300, 350, 500, 800, 1000, 1020, 1040, 1060, 1100, 1150, 1200, and 1220 of FIGS. 2, 3A, 3B, 5, 8, 10A-10D, 11A-11B, and 12A-12B discussed above. Accordingly, such computer programs represent controllers of the parallel computer system 600. Where the invention is implemented using software, the software may be stored in a computer program product and loaded into parallel computer system 600 using removable storage drive 614, interface 620, hard drive 612, or communications interface 624.

An embodiment of the invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method comprising:
determining a respective category index for each of a plurality of categories;
generating a respective class counter for each of the plurality of categories based on the respective category index;
determining, substantially simultaneously in parallel, a respective event index for each of a plurality of events associated with captured data based on respective first event values; and
incrementing, substantially simultaneously in parallel, selected ones of the respective class counters based on the respective event indices.

2. The method of claim 1, wherein all of the respective category indices have different values.

3. The method of claim 1, further comprising:
generating the respective first event values for the plurality of events based on respective second event values of the plurality of events.

4. The method of claim 1, wherein the plurality of categories is based on a plurality of thresholds.

5. The method of claim 4, wherein each one of the plurality of categories includes a respective category value comprising a plurality of category threshold values, which indicates a respective combination of zero or more satisfied thresholds and zero or more unsatisfied thresholds.

6. The method of claim 5, wherein the determining the respective category index comprises:
determining a first set of values based on the plurality of thresholds;
generating a second set of values based on the first set of values; and
compressing the respective category values using the second set of values.

7. The method of claim 6, wherein the first set of values comprises a main mask.

8. The method of claim 6, wherein the second set of values comprises a shift table.

9. The method of claim 6, further comprising:
determining a respective look up table entry for each of the respective category indices.

10. The method of claim 6, wherein a respective threshold identifier is associated with each of the plurality of thresholds.

11. The method of claim 10, wherein all of the respective threshold identifiers have different values.

12. The method of claim 10, wherein:
the determining the first set of values comprises performing a bitwise OR of the respective threshold identifiers for the plurality of thresholds; and
the first set of values comprises a plurality of first main mask values and zero or more second main mask values.

13. The method of claim 12, wherein the generating the second set of values comprises:
determining a quantity of the first main mask values within the first set of values;
determining a plurality of value positions based on locations of the first main mask values within the first set of values; and
incorporating the quantity of first main mask values and the plurality of value positions into the second set of values.

14. The method of claim 13, wherein the compressing the respective category values comprises:
selecting respective category threshold values within the respective category value based on the plurality of value positions; and
using the selected respective category threshold values to determine the respective category index.

15. The method of claim 6, wherein the determining the respective event index comprises:
compressing the respective first event values of the plurality of events using the second set of values.

16. The method of claim 15, wherein the compressing the respective first event values comprises:
selecting respective event threshold values within the respective first event values based on the plurality of value positions; and
using the selected respective event threshold values to determine the respective event index.

17. A computer readable storage medium having computer program code recorded thereon, that when executed by a host processor, causes the processor to generate a plot by a method comprising:
determining a respective category index for each of a plurality of categories;
generating a respective class counter for each of the plurality of categories based on the respective category index;
determining, substantially simultaneously in parallel, a respective event index for each of a plurality of events associated with captured data based on respective first event values; and
incrementing, substantially simultaneously in parallel, selected ones of the respective class counters based on the respective event indices.

18. The computer readable storage medium of claim 17, wherein all of the respective category indices have different values.

19. The computer readable storage medium of claim 17, wherein the method further comprises:
generating the respective first event values for the plurality of events based on respective second event values of the plurality of events.

20. The computer readable storage medium of claim 17, wherein the plurality of categories is based on a plurality of thresholds.

21. The computer readable storage medium of claim 20, wherein each one of the plurality of categories includes a respective category value comprising a plurality of category threshold values, which indicates a respective combination of zero or more satisfied thresholds and zero or more unsatisfied thresholds.

22. The computer readable storage medium of claim 21, wherein the determining the respective category index comprises:
determining a first set of values based on the plurality of thresholds;
generating a second set of values based on the first set of values; and
compressing the respective category values using the second set of values.

23. The computer readable storage medium of claim 22, wherein the method further comprises:
determining a respective look up table entry for each of the respective category indices.

24. The computer readable storage medium of claim 22, wherein a respective threshold identifier is associated with each of the plurality of thresholds.

25. The computer readable storage medium of claim 24, wherein all of the respective threshold identifiers have a different values.

26. The computer readable storage medium of claim 24, wherein:
the determining the first set of values comprises performing a bitwise OR of the respective threshold identifiers for the plurality of thresholds; and
the first set of values comprises a plurality of first main mask values and zero or more second main mask values.

27. The computer readable storage medium of claim 26, wherein the generating the second set of values comprises:
determining a quantity of the first main mask values within the first set of values;
determining a plurality of value positions based on locations of the first main mask values within the first set of values; and
incorporating the quantity of first main mask values and the plurality of value positions into the second set of values.

28. The computer readable storage medium of claim 27, wherein the compressing the respective category values comprises:
selecting respective category threshold values within the respective category value based on the plurality of value positions; and
using the selected respective category threshold values to determine the respective category index.

29. The computer readable storage medium of claim 22, wherein the determining the respective event index comprises:
compressing the respective first event values of the plurality of events using the second set of values.

30. The computer readable storage medium of claim 29, wherein the compressing the respective first event values comprises:
selecting respective event threshold values within the respective first event values based on the plurality of value positions; and
using the selected respective event threshold values to determine the respective event index.

31. An apparatus comprising:
a first memory;
a second memory; and
a plurality of processors configured to share the second memory, wherein each processor is further configured to control the display of captured data by,
determining a respective category index for each of a plurality of categories;
generating a respective class counter for each of the plurality of categories based on the respective category index;
determining, substantially simultaneously in parallel, a respective event index for each of a plurality of events associated with the captured data based on respective first event values; and
incrementing, substantially simultaneously in parallel, selected ones of the respective class counters based on the respective event indices.

32. A method comprising:
accessing a plurality of events associated with captured data;
determining first respective event values substantially simultaneously in parallel using second respective event values, wherein each of the first respective event values and each of the second respective event values corresponds to a respective event of the plurality of events; and
generating graphical representations of each of the respective events corresponding to the plurality of events substantially simultaneously in parallel based on the first respective event values corresponding to the respective events.

33. The method of claim 32, wherein the generating comprises:
determining corresponding display locations for the respective events based on the second respective event values of the respective events substantially simultaneously in parallel; and
updating first respective display location values associated with the corresponding display locations, using the first respective event values, to control which second respective display location values, associated with respective thresholds of a plurality of thresholds, is perceivable at the corresponding display locations based on respective priorities of the respective thresholds.

34. The method of claim 32, further comprising:
determining a respective category index for each of a plurality of categories; and
generating a respective class counter for each of the plurality of categories based on the respective category index,
wherein the plotting the respective events comprises,
determining, substantially simultaneously in parallel, a respective event index for each of the plurality of events based on respective first event values, and
incrementing, substantially simultaneously in parallel, selected ones of the respective class counters based on the respective event indices.

35. A method for displaying data from a biological sample, comprising:
determining a respective category index for each of a plurality of categories;
generating a respective class counter for each of the plurality of categories based on the respective category index;
receiving a biological mixture including a biological sample having a plurality of particles;
analyzing the biological mixture to measure a plurality of events, wherein each respective event corresponds to a respective one of the plurality of particles and comprises a respective plurality of parameter values;
generating respective event values for the plurality of events based on the respective pluralities of parameter values of the plurality of events;
determining, substantially simultaneously in parallel, a respective event index for each of a plurality of events associated with captured data based on respective event values;
incrementing, substantially simultaneously in parallel, selected ones of the respective class counters based on the respective event indices; and
displaying a plurality of graphical representations, wherein each graphical representation represents a value of at least one of the class counters.

36. An apparatus comprising:
a flow chamber configured to inject a biological mixture into the center of a sheath flow;
a light source configured to form a beam of light directed at the sheath flow;
a detector configured to detect scattered photons scattered from particles in the sheath flow and emitted photons released from excited fluorochromes, and converting scattered photons and emitted photons to electrical signals;
a receiver configured to receive the electrical signals and to convert the electrical signals to captured data;
a data processor, comprising,
a first memory,
a second memory, and
a plurality of processors configured to share the second memory, wherein each processor is further configured to control the display of the captured data by,
determining a respective category index for each of a plurality of categories,
generating a respective class counter for each of the plurality of categories based on the respective category index,
determining, substantially simultaneously in parallel, a respective event index for each of a plurality of events associated with the captured data based on respective first event values, and
incrementing, substantially simultaneously in parallel, selected ones of the respective class counters based on the respective event indices; and
a display configured to display the captured data.
